(19) United States
(12) Patent Application Publication
(10) Pub. No.: US 2019/0337395 A1
(43) Pub. Date: Nov. 7, 2019

(54) LEVITATION SYSTEM AND METHOD OF USING THE SAME

(71) Applicant: Eddie Oquendo Virella, Norwich, CT (US)

(72) Inventor: Eddie Oquendo Virella, Norwich, CT (US)

(21) Appl. No.: 16/044,694

(22) Filed: Jul. 25, 2018

Related U.S. Application Data
(60) Provisional application No. 62/665,062, filed on May 1, 2018.

(51) Int. Cl. B60L 13/04; H01F 7/02; H01F 6/04; H02N 15/00; G03H 1/00; G03H 1/26; B60K 3/04

(52) U.S. Cl. CPC B60L 13/04; H01F 7/0236; H01F 6/04; G03H 2223/24; G03H 1/0005; G03H 1/268; B60K 3/04; H02N 15/00

(57) ABSTRACT

A levitation system includes a platform including a superconductor material; a hydrogen generator mounted on a first surface of the platform; an optical interface system mounted on at least a second surface of the platform, the optical interface system includes at least one light source configured to emit light having a predetermined wavelength; and a plurality of magnetized light reflectors configured to transmit magnetized light by reflecting the emitted light from the at least one light source; an electricity generator electrically coupled to at least one battery, the at least one battery configured to provide power to the optical interface system; and a controller comprising a memory and a processor, the controller configured to control the hydrogen generator, the optical interface system, and the electricity generator to cause the optical interface system to generate a magnetic field associated with the emitted light to repel a magnetic field of the superconductor material. Magnetized light transmitted by the plurality of magnetized light reflectors is useable for generating a magnetic field around the platform.

### CROSS-REFERENCE TO RELATED APPLICATIONS

The present disclosure claims the benefit of and priority to U.S. Provisional Application No. 62/665,062, titled “A LEVITATION SYSTEM AND METHOD OF USING THE SAME,” filed May 1, 2018, the disclosure of which is incorporated herein by reference in its entirety.

### FIELD

The present disclosure relates generally to a levitation system, in particular a levitation system that uses a superconductor to generate a magnetic field.

### BACKGROUND

Self-powered vehicles are commonly used for transportation. Ground transportation vehicles, such as automobiles, are in wide use. Although ground transportation is often desired for its flexibility and ability to reach a very large number of destinations, it is generally restricted to particular routes. For example, cars and buses must use roads, not only because of traffic regulations but also because cars and buses require a clear path of travel due to their relatively limited ability to navigate obstacles that would otherwise appear on a travel path. Such obstacles include both naturally occurring objects (such as vegetation or rocky terrain) but also artificially occurring objects (such as buildings). Accordingly, ground transportation vehicles travel along pre-defined travel paths that avoid such obstacles. Because of this, the path of travel for ground transportation obstacles is not necessarily the shortest or straightest path to a given destination. The increased distance required to travel increases both the time it takes for a passenger to travel but also increases the fuel consumed by the vehicle during travel.

However, vehicles for air transportation are relatively rarer because they are generally more expensive to manufacture (in part because air transportation vehicles are much larger than ground transportation vehicles) and are more expensive to operate. Although air transportation vehicles can easily avoid ground-based obstacles, air travel is generally restricted to longer distances, given the relatively high operational costs and because most ground locations are not suitable for the takeoffs and landings of air transportation vehicles, given size and terrain constraints. However, an air transportation vehicle which is of a similar size as a ground transportation vehicle could achieve the benefits of air travel while avoiding some of the additional costs currently associated with long-range air travel.

### SUMMARY

The following presents a general summary of aspects of the present disclosure in order to provide a basic understanding of the disclosure. This summary is not an extensive overview of the disclosure and is not intended to identify key or critical elements of the invention or to delineate the scope of the present disclosure. The following summary merely presents some concepts of the present disclosure in a general form as a prelude to the more detailed description provided below.

According to one exemplary embodiment of the present disclosure, a levitation system includes a platform including a superconductor material; a hydrogen generator mounted on a first surface of the platform; an optical interface system mounted on at least a second surface of the platform, the optical interface system including at least one light source configured to emit light having a predetermined wavelength, and a plurality of magnetized light reflectors configured to transmit magnetized light by reflecting the emitted light from the at least one light source; an electricity generator electrically coupled to at least one battery, the at least one battery configured to provide power to the optical interface system; and a controller including a memory and a processor, the controller configured to control the hydrogen generator, the optical interface system, and the electricity generator to cause the optical interface system to generate a magnetic field associated with the emitted light to repel a magnetic field of the superconductor material. Magnetized light transmitted by the plurality of magnetized light reflectors is useable for generating a magnetic field around the platform.

According to another exemplary embodiment of the present disclosure, a vehicle for levitated transportation includes a passenger compartment; a superconducting material mounted to a surface of the passenger compartment; pipes configured to receive a flow of liquid hydrogen throughout the superconducting material and thereby maintain a temperature of the superconducting material below a critical temperature of the superconducting material; an optical interface system mounted to the surface of the passenger compartment; and a controller including a memory and a processor, the controller configured to control the optical interface system. The optical interface system includes at least one laser source and at least one magnetized laser reflector. The at least one magnetized laser reflector is configured to reflect light emitted from the at least one laser source to create a combined magnetic field below around the surface of the passenger compartment that repels a magnetic field of the superconducting material.

According to yet another exemplary embodiment of the present disclosure, a method for levitating a vehicle includes the steps of cooling a superconducting material below a critical temperature of the superconducting material, the superconducting material being mounted on a surface of the vehicle; emitting magnetized light from a light source mounted on at least the surface of the vehicle; reflecting the magnetized light from the light source using at least one magnetized light reflector; generating a magnetic field between the surface of the vehicle and a ground surface; and repelling the surface of the vehicle away from the ground surface based on the magnetic field repelling the superconducting material.

### BRIEF DESCRIPTION OF THE DRAWINGS

Features, aspects, and advantages of the present invention will become apparent from the following description and the accompanying exemplary embodiments shown in the drawings, which are briefly described below.

FIG. 1 shows a schematic diagram illustrating a levitation system, according to an exemplary embodiment.

FIG. 2 shows a schematic diagram illustrating components of a hydrogen generator of the levitation system shown in FIG. 1.

FIG. 3 shows a rear perspective view of the levitation system shown in FIG. 1.

FIG. 4 shows a side perspective view of the levitation system shown in FIG. 1.

FIG. 5 shows a side perspective view of the levitation system according to some aspects.

FIG. 6 shows a side view of a vehicle for levitated transportation, according to an exemplary embodiment.

FIG. 7 shows a bottom perspective view of the vehicle for levitated transportation shown in FIG. 6.

FIG. 8 shows a flow chart illustrating a process for levitating a vehicle for transportation, according to an exemplary embodiment.

### DETAILED DESCRIPTION

Following below are more detailed descriptions of various concepts related to, and implementations of exemplary devices and methods. The various concepts introduced above and discussed in greater detail below may be implemented in any of numerous ways, as the described concepts are not limited to any particular manner of implementation.

Referring generally to the figures, systems and methods for levitating a vehicle which includes a superconductor for generating a magnetic field are described. A superconductor is a material which is characterized by zero electrical resistivity when a temperature of the material is below a critical temperature. A superconductor also exhibits the property of diamagnetism; that is, superconductors are perfect diamagnets with a magnetic susceptibility of −1. A diamagnet is characterized by the generation of a repulsive force in a material which is subjected to an applied magnetic field. The repulsive force is caused by the quantum mechanical effect by which an applied magnetic field creates an induced magnetic field in the material which is directly opposed to the direction of the applied magnetic field. Diamagnetism is also characterized by a magnetic permeability less than unity and by a negative magnetic induction.

Quantum locking or quantum levitation refers to the phenomenon of a superconductor material perfectly matching an applied magnetic field. Due to the Meissner effect, which is only exhibited by type I superconductors, when a superconductor material is cooled below a critical temperature of the material and when an applied magnetic field is subsequently applied to the superconductor, a magnetic field inside the superconductor becomes zero. The magnetic field within the superconductor falls to zero because superconducting currents on the surface of the superconductor produce a second magnetic field that cancels out the applied magnetic field. Using this effect, magnetic levitation can be achieved due to the repulsion between a permanent magnet which produces the applied magnetic field and the magnetic field produced by the induced currents inside the superconductor.

A laser beam is a very narrow light beam which is coherent and intense. The coherence renders a laser beam useful in the production of holograms, which are patterns of light interference produced by a beam of radiation which has been split. Additionally, a laser beam can be used to levitate objects; if the laser beam is sufficiently focused on a region of space, the laser beam can generate a push or a pull force on an object. However, laser levitation has been restricted to levitation of only very small objects (for instance, microscopic or nanoscopic particles) because of the large energy demands required to generate the focused laser beam for levitating the particles. Laser levitation usually requires a combination of carefully manipulated foot acoustic waves to levitate. By focusing the laser light pulses, an electric field (for example, on the orders of magnitude greater than those found within atoms) can be generated. The high energy photons produced by this process interact with the strong laser field and create electron-positron pairs. While it has not been feasible to use laser beams in the levitation of larger-scale macroscopic objects, such as vehicles used for transportation, the present solution can overcome these shortcomings. For example, the present solution can be used in various applications, including transportation applications, using a quantum locking mechanism combined with laser levitation, to provide a low-cost form of transportation which is easily adaptable to many different contexts and which allows for a reduction in energy costs associated with current transportation systems.

A hologram, as used herein, refers to a pattern of light interference which is produced by a beam of radiation (for example, a laser) which has been split or an image produced by the pattern of light interference.

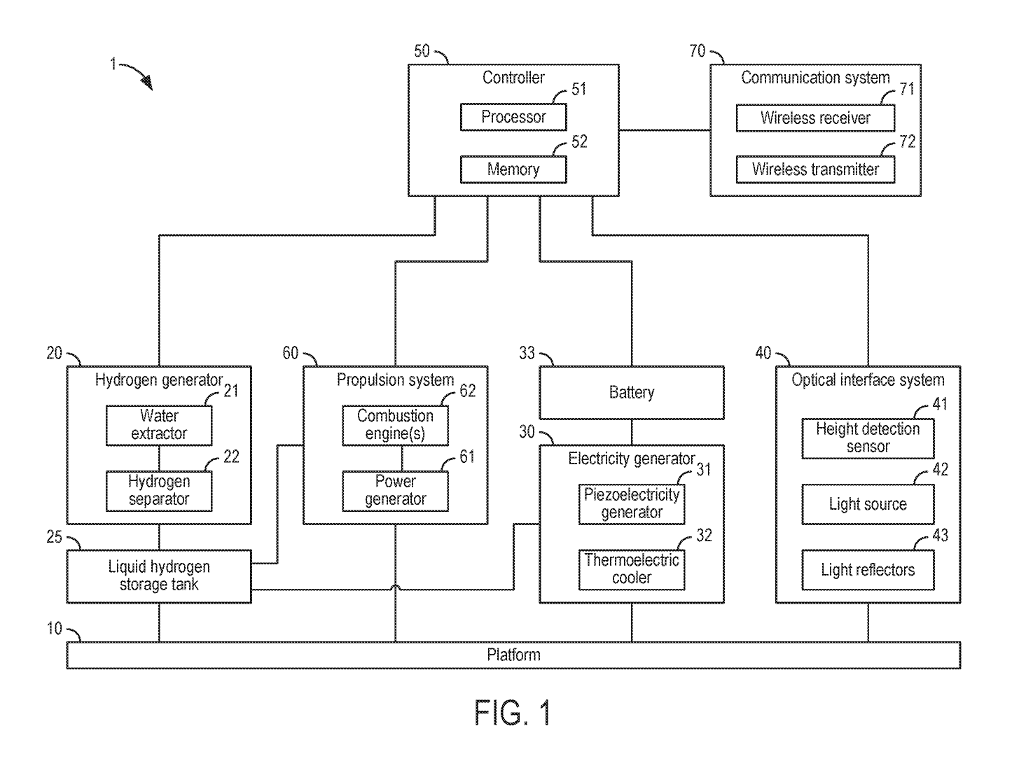

As shown in FIG. 1, a levitation system 1 includes a platform 10. A storage tank 25 is mounted on a surface of the platform 10. The storage tank 25 is fluidly coupled to a hydrogen generator 20. The storage tank 25 is also fluidly coupled to a propulsion system 60 which is mounted on a side of the platform 10. The liquid hydrogen storage tank 25 is also fluidly coupled to an electricity generator 30 which is mounted on a surface of the platform 10. The electricity generator 30 is also electrically coupled to a battery 33. An optical interface system 40 is mounted to another surface of the platform 40.

### Platform

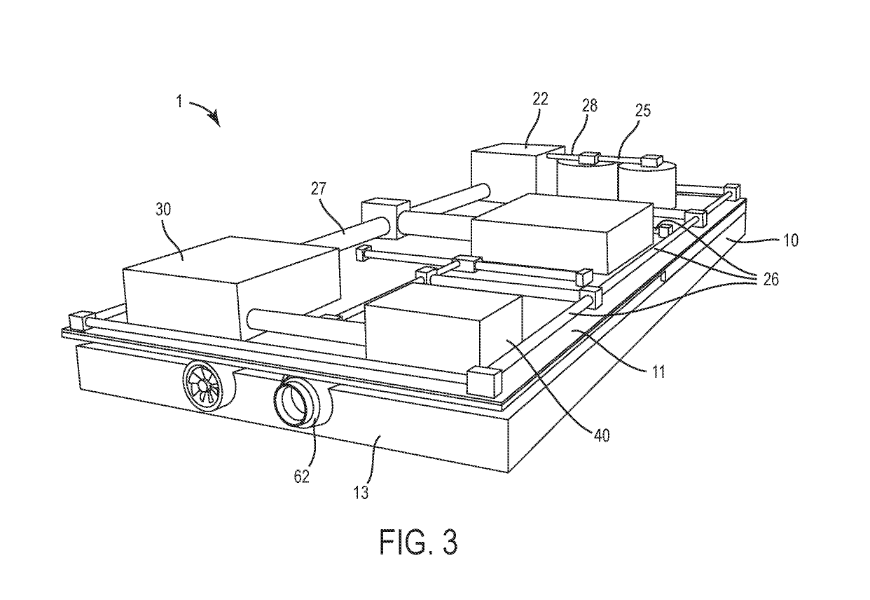

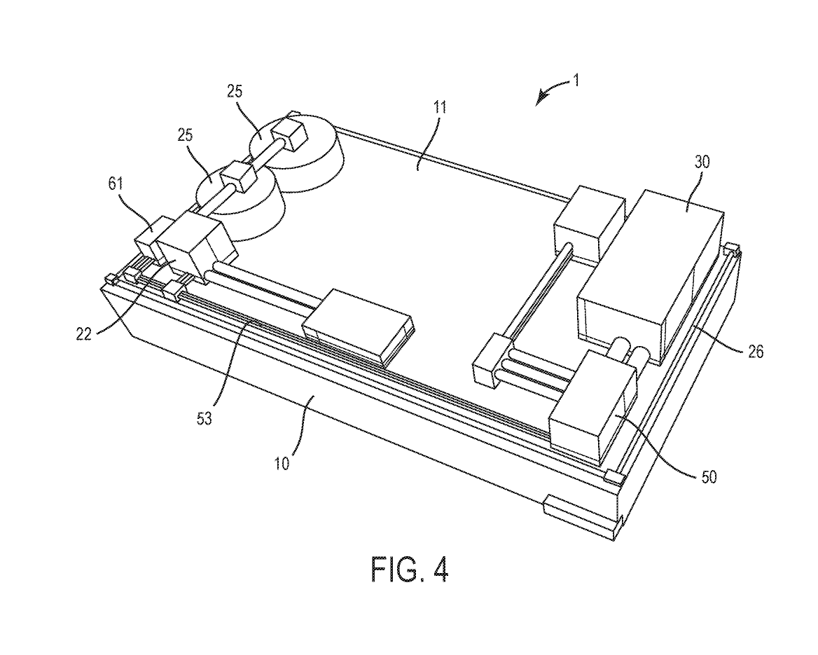

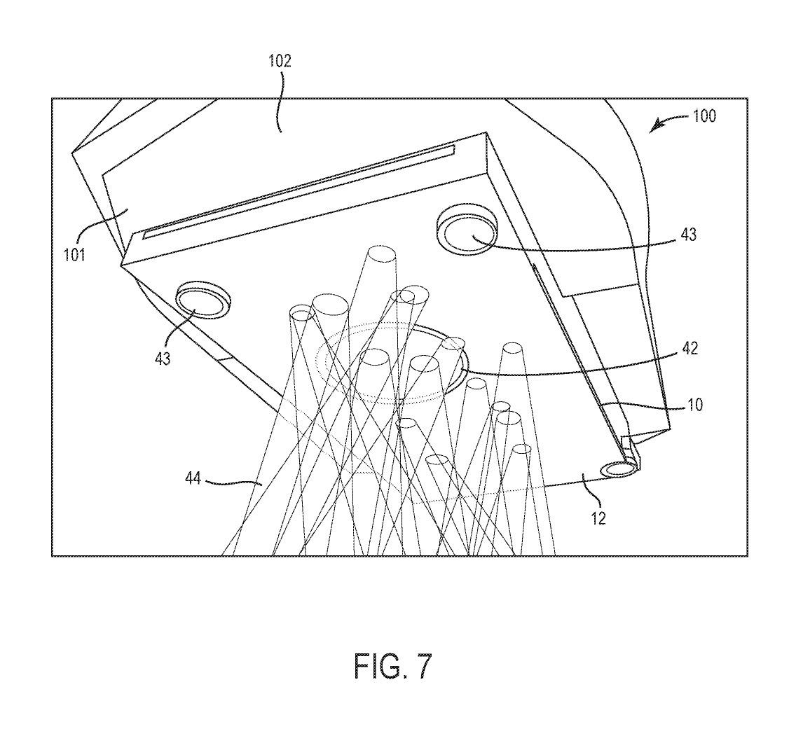

Referring to FIGS. 3-4, the platform 10 includes a top surface 11 and a bottom surface 12 (shown in FIG. 7). Referring back to FIG. 3, the platform 10 also includes at least one side 13. The platform 10 is formed of a superconductor material. The platform 10 is of any suitable size and shape and is configured to house and/or support the other components of the levitation system 1 as described below in more detail. For example, platform 10 is of a size and shape suitable for serving as a bottom surface or base of a vehicle used for transportation (e.g., an automobile). As shown in FIGS. 3-7, the platform 10 has a rectangular solid shape, but the platform 10 is not particularly limited to this implementation. For example, the platform 10 may be any shape such that a user may be able to sit either directly or indirectly on the platform 10 while using the levitation system 10 for transportation.

Because the platform 10 is made of a superconductor material, the platform 10 is capable of levitation. When the superconducting material of the platform 10 absorbs liquid hydrogen at zero point, a quantum gravity field is created. The generated quantum gravity field is useable in generating the holograms produced by the optical interface system, as is described in more detail below.

### Hydrogen and Fuel System

As shown in FIG. 3, the levitation system 1 also includes a storage tank 25 which is mounted on a top surface 11 of the platform 10. The storage tank 25 is mounted to the platform 10 by any suitable means. The storage tank 25 is configured to store a predetermined amount of liquid hydrogen.

A hydrogen generator 20 is mounted on the top surface 11 of the platform 10. The hydrogen generator 20 is fluidly coupled to the storage tank 25 and is configured to provide a flow of liquid hydrogen to the storage tank 25. As shown in FIG. 1, the hydrogen generator 20 includes a water extractor 21 which is configured to extract water from the ambient air. According to one aspect, the water extractor 21 is an atmospheric water generator (AWG) which extracts water vapor from humid, ambient air. The AWG cools the air below its dew point to condense the water vapor and expose the air to desiccants. An AWG operates similar to a conventional dehumidifier, but the AWG is also capable of producing potable water from the ambient air.

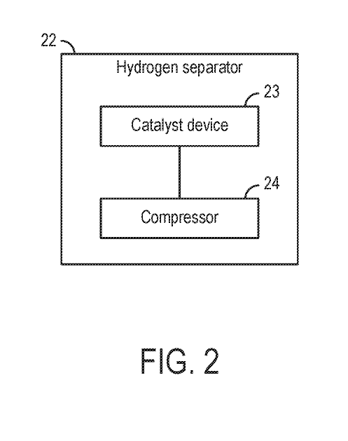

A hydrogen separator 22 is fluidly coupled to the water extractor 21 and is configured to receive a flow of water from the water extractor 21. The hydrogen separator 22 is configured to separate the hydrogen and oxygen which constitute the water. To accomplish the separation process, the hydrogen separator 22 includes a catalyst device 23, as shown in FIG. 2. The catalyst device 23 separates hydrogen from oxygen in water, H₂O, and produces hydrogen gas. Once the hydrogen has been separated from the water provided by the water extractor 21, and the hydrogen gas has been produced by the catalyst device 23, the hydrogen gas is compressed into a liquid state by the compressor 24 of the hydrogen separator into liquid hydrogen which is provided to the storage tank 25 via the pipes 28. Liquid hydrogen may then be made available to other components of the system 1 via the pipes 26 (shown in FIGS. 3-4). For example, liquid hydrogen may be provided to the platform 10 to cool the platform below its critical temperature. As another example, the liquid hydrogen is provided to the propulsion system 60 (described below) to be used as a primary fuel to propel the platform in a lateral direction.

### Propulsion System

The system 1 also includes a propulsion system 60, such as a mechanical propulsion system. The propulsion system 60 is configured to propel the platform in a lateral direction (that is, in a direction approximately parallel to a ground surface). As shown in FIG. 1, the propulsion system 60 includes a power generator 61 which is configured to receive a flow of hydrogen fuel from the storage tank 25 and use the hydrogen fuel to generate power. Additionally, as shown in FIG. 1 and FIG. 3, the propulsion system 60 includes one or more combustion engines 62. The one or more combustion engines 62 are mounted to the side 13 of the platform 10 and are thereby supported by the platform 10, as shown in FIG. 3. Although FIG. 3 shows both of the one or more combustion engines 62 mounted to a same side 13 of the platform 10, each of the one or more combustion engines 62 may be connected to different sides of the platform 10. According to one aspect, the one or more combustion engines 62 are power-driven turbine engines. According to another aspect, the one or more combustion engines 62 are jet engines which are configured to produce propulsion by ejecting fluids at a high speed from the jet engines such that the motion impulse of the one or more combustion engines 62 equals the mass of air multiplied by the speed with which the or more combustion engines 62 expels that mass.

In some embodiments, propulsion system 60 includes a piezoelectric system. The piezoelectric system can include a cylinder including an inlet to receive at least one of a liquid or hydrogen gas, such as an inlet coupled to the storage tank 25. The piezoelectric system can include a superconducting material, and can include a magnet that is adjacent to (e.g., below) the superconducting material. When hydrogen is received in the superconductor via the inlet, the hydrogen is cooled, providing a repulsive magnetic field, and causing the Meissner effect and a flux pinning phenomenon. The piezoelectric system includes an actuator (e.g., hydraulic actuator, mechanical actuator) that can compress the superconducting material (which may be suspended in the air and/or on the magnet), resulting in a pressure/mechanical force that the piezoelectric system can convert into electricity. The force and/or electricity can be sent to a battery, or to the electricity generator 30 discussed below. The controller 50 discussed below can monitor data regarding operation of the piezoelectric system, such as to control a flow rate of the hydrogen to the piezoelectric system, mechanical hardness of the piezoelectric system, and/or an energy level associated with operation of the piezoelectric system.

### Power System

The system 1 also includes an electricity generator 30 which is mounted on the top surface 11 of the platform 10, as is shown in FIG. 3. The electricity generator 30 is fluidly coupled to the storage tank 25. The electricity generator 30 is configured to produce electricity and provide the electricity to at least one battery 30 which is electrically coupled to the electricity generator 30. The electricity generator 30 is configured to capture and/or collect wireless electromagnetic signals and convert the radio frequency signals into the electrical energy which is stored in the at least one battery 33. According to one aspect, the electricity generator 30 includes a piezoelectricity generator 31 and a thermoelectric cooler 32. According to this aspect, the electricity generator 30 subjects certain crystals to mechanical stresses and thereby produces an electric polarization resulting in a difference in potential electrical charges on the surface of the crystals. The degradation of the crystals in this manner is highly correlated with temperature. Additionally, according to this aspect, the thermoelectric cooler 32 directly converts the temperature differential on the surface of the crystal to an electrical voltage and thereby can be used to generate an electrical current to supply to the at least one battery 33.

### Optical Interface System

Referring to FIG. 1, the system 1 also includes the optical interface system 40. The optical interface system 40 is mounted to the bottom surface 12 of the platform 10, as is shown in FIG. 7. Referring back to FIG. 1, the system 1 includes a height detection sensor 41 which is configured to detect a distance from the bottom surface 12 of the platform 10 to a ground surface. The optical interface system 40 also includes at least one light source 42 which is configured to emit light. As one example, the at least one light source 42 is a laser source. The optical interface system 40 also includes a plurality of light reflectors 43 which are configured to magnetize the light emitted by the at least one light source 42 and reflect the magnetized light to the ground surface to levitate the platform 10.

The optical interface system 40, including the light source 42 and the light reflectors 43, is configured to produce an applied magnetic field which automatically magnetizes light emitted from the light source 42 and projects the magnetized light below the platform 10. The projected magnetized light can be in the form of a 3D hologram which uses the intensity of magnetized light rays that form a magnetic well. As one example, the optical interface system 40 is configured to project a laser light tractor beam which is useable in repelling the platform 10 from a ground surface. The optical interface system 40 is also configured to combine multiple light pulses together (for example, by using a synthesizer), and create a light field which includes light pulses.

The optical interface system 40 is configured to produce a holographic magnetic-sensitive image and project the holographic magnetic sensitive image at an acute angle onto a surface (such as a ground surface) over or above which the system 1 is oriented. The holographic magnetic sensitive image includes a holographic image which includes at least one coherent light beam 44 and which simulate separate 2D hologram images to create a 3D magnetic holographic image. The controller 50 (described below) is configured to control a direction and/or intensity of the light beam 44 when it is emitted and/or projected. In addition, the light reflectors 43 (such as deformable mirrors) are configured to be controllable by the controller 50 to control a direction in which the at least one light beam 44 is reflected. The total field size of the projected image is scaled with the wavelength of the light used to illuminate the ground; for example, red light is diffracted more by spatial light modulation pixels of the optical interface system than the blue light, and thus gives rise to a larger total field size. Additionally, there may be provided an optical holographic-sensitive imaging platform (not shown) which is configured to reflect the surface (e.g., a ground surface) on which a modulated electromagnetic image is projected. The optics and the use of magnetic light allows a remote tactile detection system to be hidden behind a black transmitter window, and the infrared light does not diminish the visual appearance of the holographically displayed image.

When the temperature of the platform 10 is lowered, the superconductor of the platform 10 expels the magnetic field of the hologram projected by the optical interface system 40, thereby levitating the platform 10 above the ground surface. For example, when the optical interface system 40 creates a magnetic field due to the magnetized light beams 44, the cooled superconductor of the platform 10 repels the magnetic field and generates a force which repels the magnetic field of the hologram between the platform 10 and the ground surface. In this manner, the superconductor platform 10 is levitated off the ground by creating a repulsive magnetic force which conserves a magnetic flux within the superconductor and decreases the magnetic flux field outside the superconductor.

Accordingly, the optical interface system 40 is configured to transmit 3D images by projecting the magnetized light beams 44 below the platform 10. The magnetized light beams 44 which create the 3D electromagnetic hologram generates an intensity of magnetic attraction below the superconductor of the platform 10 and creates a magnetic force when the superconductor reaches zero-point field. The magnetic force results in a repulsive force between the platform and the magnetic field, thereby levitating the platform.

### Communication System

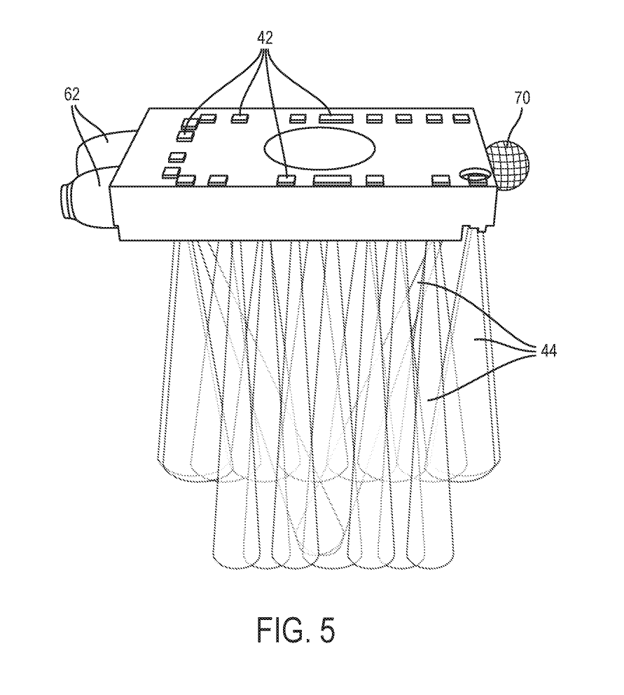

As shown in FIG. 5, the system 1 also includes a communication system 70. The communication system includes a wireless receiver 71 configured to receive wireless signals from an external source (not shown) and a wireless transmitter 72 configured to transmit wireless signals from an external source (not shown).

### Controller

As shown in FIG. 1, the system 1 also includes a controller 50. The controller 50 is an electronic control unit that is configured to manage and control the various components of system 1. The controller 50 includes a memory 52 and a processor 51 and is powered by the at least one battery 33. The controller 50 is configured to control any of the components of the system 1. For example, the controller 50 is programmable to control the operation of the hydrogen generator 20 to increase or decrease the amount of hydrogen produced. The controller 50 may also be programmable to control the operation of the one or more combustion engines 62 which provide a propulsive impetus to the platform 10. The controller 50 may also be programmable to control the electricity generator 30 to increase or decrease the amount of electrical energy provided to the battery 33. Additionally, the controller 50 is programmable to control the operation of the optical interface system 40 by controlling the amount of light emitted by the at least one light source 42 and/or the magnetization of the light by the plurality of light reflectors 43. Additionally, the controller 50 is programmable to control the operation of the communication system 70.

The controller 50 is also configured to send a signal to the electricity generator 30. For example, the controller 50 is configured to control a flow (e.g., a rate of flow) from the hydrogen generator 20 to the electricity generator 30 such that the platform 10 remains at or below the zero-point cold temperature of the superconductor material. The controller 50 is also configured to send a signal to the optical interface system 40 to produce magnetized laser beams to produce a 3D hologram useable for levitating the platform 10. The controller 50 is programmable to combine and manage all of the various components of the system 1 and allows for simultaneous execution of a variety of control tasks. The controller 50 is programmable to combine and calculate the distance between the platform 10 and a ground surface. Additionally, the controller 50 is programmable to control holographic fields of the light beam 44 to maintain a distance between the platform and the ground surface.

### Vehicle

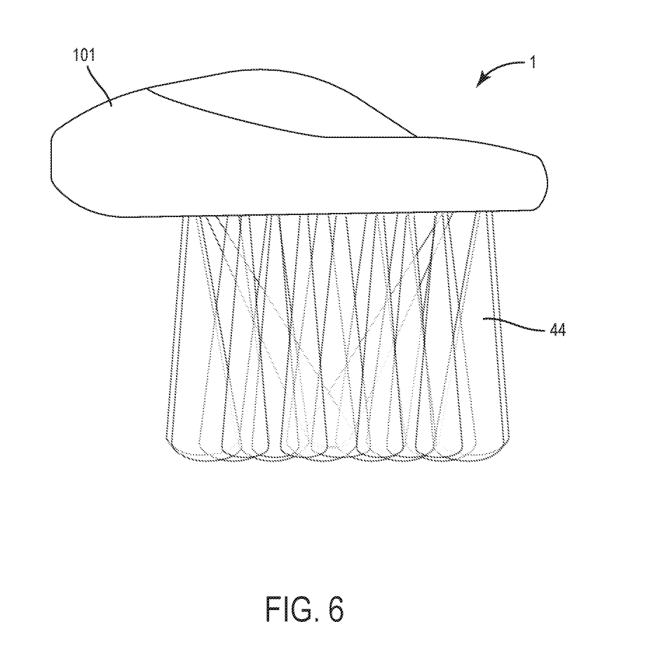

According to an exemplary embodiment of the present disclosure, a vehicle for levitated transportation is shown in FIGS. 6-7. The vehicle 100 includes a passenger compartment 101 which is configured to house or hold a predetermined number of passengers. The vehicle 100 also includes a bottom surface 102 which is configured to be connected to the platform 10 of the system 1 described above. The vehicle 100 can be any of a variety of vehicles, including but not limited to ground-based vehicles, airborne vehicles, or space vehicles. The vehicle 100 can include an automatic landing system. The vehicle 100 can include environmental control systems, such as a heating system and a temperature control system. In some embodiments, the vehicle 100 includes an energy output interface that can be used to output energy generated by the vehicle 100, such as to sell energy generated by the vehicle via an energy meter of the energy output interface to a remote energy grid or other energy receiver. The vehicle 100 can include an autonomous driving sensor system and controller to enable the vehicle 100 to operate autonomously.

The vehicle 100 can be any commercially available vehicle made of any suitable material. For example, the vehicle 100 can be made of a superconductive material, plastic material, glass, or metal. The interior of the passenger compartment 101 vehicle 100 includes an aerial control system (not shown) for controlling the motion of the vehicle 100, for example, by an operator of the vehicle 100. The vehicle 100 is also configured to be placed on any object (for example, when the vehicle 100 is parked and not in use), and the vehicle 100 is configured to float above any surface.

### Method

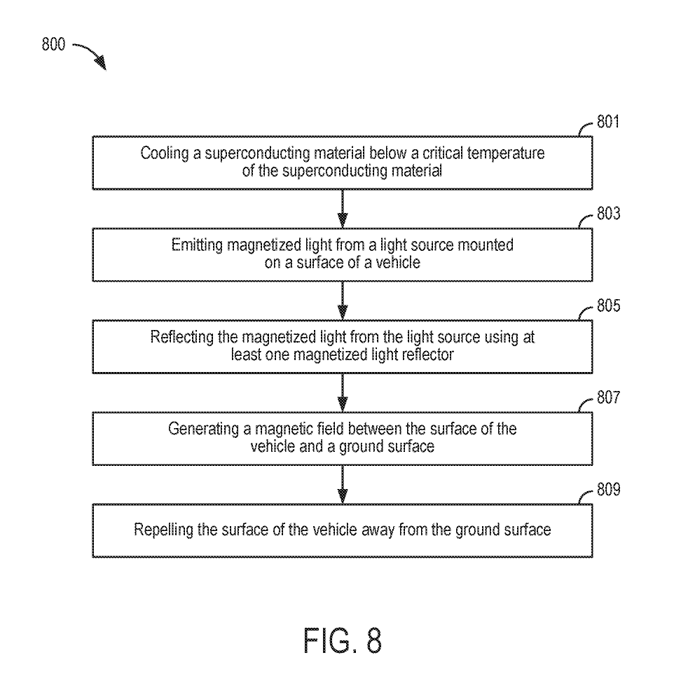

According to an exemplary embodiment of the present disclosure, a method 800 for levitating a vehicle (such as the vehicle 100 using the system 1, described above) is illustrated in FIG. 8. The method 800 includes the step 801 of cooling a superconducting material below a critical temperature of the superconducting material, the superconducting material being mounted on a surface of the vehicle. The method 800 also includes the step 803 of emitting magnetized light from a light source mounted on at least the surface of the vehicle. The method 800 also includes the step 805 of reflecting the magnetized light from the light source using at least one magnetized light reflector. The method 800 also includes the step 807 of generating a magnetic field between the surface of the vehicle and a ground surface. The method 800 also includes the step 809 of repelling the surface of the vehicle away from the ground surface. According to one aspect of the method 800, the superconducting material is cooled by absorbing liquid hydrogen at zero point. According to another aspect, the method 800 also includes the step of adjusting a strength of the magnetic field using a controller.

As utilized herein, the terms “approximately,” “about,” “substantially,” and similar terms are intended to have a broad meaning in harmony with the common and accepted usage by those of ordinary skill in the art to which the subject matter of the disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of this disclosure as recited in the appended claims.

The terms “coupled,” “connected,” and the like are used herein to mean the joining of two members directly or indirectly to one another. Such joining may be stationary (e.g., permanent) or moveable (e.g., removable or releasable). Such joining may be achieved with the two members or the two members and any additional intermediate members being integrally formed as a single unitary body with one another or with the two members or the two members and any additional intermediate members being attached to one another.

References herein to the position of elements (e.g., “top,” “bottom,” “above,” “below,” etc.) are merely used to describe the orientation of various elements in the Figures. It should be noted that the orientation of various elements may differ according to other exemplary embodiments and that such variations are intended to be encompassed by the present disclosure.

It is to be understood that although the present invention has been described with regard to embodiments thereof, various other embodiments and variants may occur to those skilled in the art, which are within the scope and spirit of the invention, and such other embodiments and variants are intended to be covered by corresponding claims. Those skilled in the art will readily appreciate that many modifications are possible (e.g., variations in sizes, structures, shapes and proportions of the various elements, mounting arrangements, use of materials, orientations, etc.) without materially departing from the novel teachings and advantages of the subject matter described herein. For example, the order or sequence of any process or method steps may be varied or re-sequenced according to alternative embodiments. Other substitutions, modifications, changes, and omissions may also be made in the design, operating conditions and arrangement of the various exemplary embodiments without departing from the scope of the present disclosure.

With respect to the use of substantially any plural and/or singular terms herein, those having skill in the art can translate from the plural to the singular and/or from the singular to the plural as is appropriate to the context or application. The various singular/plural permutations may be expressly set forth herein for clarity.

What is claimed is:

1. A levitation system comprising:
a platform comprising a superconductor material;
a hydrogen generator mounted on a first surface of the platform;
an optical interface system mounted on at least a second surface of the platform, the optical interface system comprising
at least one light source configured to emit light having a predetermined wavelength; and
a plurality of magnetized light reflectors configured to transmit magnetized light by reflecting the emitted light from the at least one light source;
an electricity generator electrically coupled to at least one battery, the at least one battery configured to provide power to the optical interface system; and
a controller comprising a memory and a processor, the controller configured to control the hydrogen generator, the optical interface system, and the electricity generator by causing the optical interface system to generate a magnetic field associated with the emitted light to repel a magnetic field of the superconductor material,
wherein magnetized light transmitted by the plurality of magnetized light reflectors is useable for generating a magnetic field around the platform.

2. The levitation system of claim 1, wherein the hydrogen generator is configured to provide a flow of liquid hydrogen through the platform and thereby maintain a temperature of the platform below a critical temperature of the superconductor material of the platform.

3. The levitation system of claim 1, wherein the hydrogen generator comprises a water extractor configured to extract water from moist ambient air.

4. The levitation system of claim 3, wherein the hydrogen generator further comprises a hydrogen separator comprising
a catalyst device configured to separate hydrogen from the water extracted by the water extractor; and
a compressor configured to compress the hydrogen into a liquid state.

5. The levitation system of claim 4, wherein the hydrogen generator is fluidly coupled to at least one hydrogen storage tank mounted on the first surface of the platform, the at least one hydrogen storage tank configured to store liquid hydrogen.

6. The levitation system of claim 5, wherein the at least one hydrogen storage tank is fluidly coupled to pipes configured to distribute liquid hydrogen throughout the platform.

7. The levitation system of claim 1, wherein the at least one light source comprises at least one laser source.

8. The levitation system of claim 1, wherein the optical interface system further comprises a height detection sensor configured to detect a distance between the second surface of the platform and a ground surface.

9. The levitation system of claim 1, wherein the electricity generator comprises a piezoelectricity generator.

10. The levitation system of claim 1, wherein the electricity generator comprises a thermoelectric cooler configured to receive a flow of liquid hydrogen.

11. The levitation system of claim 1, further comprising a communication system connected to the controller and comprising a wireless receiver and a wireless transmitter.

12. The levitation system of claim 11, wherein the controller is configured to send a control signal to one or more of the hydrogen generator, the optical interface system, and the electricity generator, based on a signal received from the wireless receiver.

13. A vehicle for levitated transportation, the vehicle comprising:
a passenger compartment;
a superconducting material mounted to a surface of the passenger compartment;
pipes configured to receive a flow of liquid hydrogen throughout the superconducting material and thereby maintain a temperature of the superconducting material below a critical temperature of the superconducting material;
an optical interface system mounted to the surface of the passenger compartment, the optical interface system comprising
at least one laser source; and
at least one magnetized laser reflector; and
a controller comprising a memory and a processor, the controller configured to control the optical interface system,
wherein the at least one magnetized laser reflector is configured to reflect light emitted from the at least one laser source to create a combined magnetic field below around the surface of the passenger compartment that repels a magnetic field of the superconducting material.

14. The vehicle of claim 13, further comprising a propulsion system configured to provide a lateral impulse on the vehicle such that the vehicle is propulsed in a lateral direction relative to a ground surface.

15. The vehicle of claim 14, wherein the propulsion system comprises one or more jet engines.

16. The vehicle of claim 15, wherein the one or more jet engines are turbine-powered jet engines.

17. The vehicle of claim 13, further comprising an electricity generator configured to generate electricity and provide the generated electricity to a battery configured to store electrical energy.

18. A method for levitating a vehicle, the method comprising:
cooling a superconducting material below a critical temperature of the superconducting material, the superconducting material being mounted on a surface of the vehicle;
emitting magnetized light from a light source mounted on at least the surface of the vehicle;
reflecting the magnetized light from the light source using at least one magnetized light reflector;
generating a magnetic field between the surface of the vehicle and a ground surface; and
repelling the surface of the vehicle away from the ground surface based on the magnetic field repelling the superconducting material.

19. The method of claim 18, wherein the superconducting material is cooled by absorbing liquid hydrogen at zero point.

20. The method of claim 18, further comprising adjusting a strength of the magnetic field using a controller.
